(19) United States
(12) Patent Application Publication
(10) Pub. No.: US 2021/0004512 A1
(43) Pub. Date: Jan. 7, 2021

(54) TOPOLOGY OPTIMIZATION WITH DESIGN-DEPENDENT LOADS AND BOUNDARY CONDITIONS FOR MULTI-PHYSICS APPLICATIONS

(71) Applicant: Siemens Aktiengesellschaft, Munich (DE)

(72) Inventors: Tsz Ling Elaine Tang, Plainsboro, NJ (US); Suraj Ravi Musuvathy, Princeton Junction, NJ (US); Dan Lior, Houston, TX (US); Songtao Xia, Lawrenceville, NJ (US); Wentao Fu, Orlando, FL (US); Lucia Mirabella, Plainsboro, NJ (US)

(73) Assignee: Siemens Aktiengesellschaft, Munich (DE)

(21) Appl. No.: 16/977,306

(22) PCT Filed: Mar. 13, 2019
(86) PCT No.: PCT/US2019/022010

§ 371 Date: Sep. 1, 2020

Related U.S. Application Data
(60) Provisional application No. 62/643,778, filed on Mar. 16, 2018.

(51) Int. Cl. G06F 30/23; G06F 111/04; G06F 119/18; G06F 119/08; G06F 113/10

(52) U.S. Cl. CPC G06F 30/23; G06F 2111/04; G06F 2113/10; G06F 2119/08; G06F 2119/18

(57) ABSTRACT

A system includes a meshing module, one or more physics solvers, one or more sensitivity computation modules, and one or more optimizer modules. The meshing module generates a mesh of a design domain corresponding to an object to be manufactured. The physics solvers each generate physical field variables and objective values based on the mesh and boundary conditions specified on solid-void boundaries of the design domain. The sensitivity computation modules compute a sensitivity field based on the mesh and the physical field variables. The optimizer modules generate an updated design comprising new design variables by executing an optimization of the design domain based on the sensitivity field and the objective values. The physics solvers, the sensitivity computation modules, and the optimizer modules are iteratively executed until convergence to generate a final design based on the new design variables generated by the optimizer modules.

### CROSS REFERENCE TO RELATED APPLICATIONS

This application is the US National Stage of International Application No. PCT/US2019/022010 filed 13 Mar. 2019, and claims the benefit thereof. The International Application claims the benefit of U.S. Provisional Application No. U.S. 62/643,778 filed 16 Mar. 2018. All of the applications are incorporated by reference herein in their entirety.

### TECHNICAL FIELD

The present disclosure is directed, in general, to a topology optimization framework that is able to account for design-dependent load and boundary conditions. The technology described herein is particularly well-suited for, but not limited to, additive manufacturing and other similar fabrication methods.

### BACKGROUND

Topology optimization has gained popularity recently in generating new designs, given its flexibility in generating freeform designs, which can potentially offer superior product performance and cost reduction. The advancement in additive manufacturing technology has also enabled the production of very complex shapes. Currently, most topology optimization solvers used for design often involve a single type of physics (structural analysis is the most common type), and also only involve simplified loads and boundary conditions (i.e., these conditions are not expected to change with the design). However, for the performance of a lot of products, other types of physics are often involved, such as heat transfer and fluid flow. For example, in aerodynamic components, the structure is often surrounded by a fluid that also exerts both structural (e.g., pressure load) and thermal loads (e.g., heat flux) to the structure. Therefore, in addition to mechanical performance requirements, the design needs to be able to account for the product's thermal performance (e.g., minimum thermal load, maximum allowable temperature constraint).

There are a number of challenges to extend topology optimization to more complex problems. For example, combustion engine applications often necessitate the inclusion of thermal analysis in topology optimization. However, this is not straightforward, as the optimization not only needs to account for the conduction of the internal structure of the object, but also convection of the solid to a surrounding fluid, which is dependent on the surface area of the solid. Moreover, this surface is constantly evolving with the optimization. In addition to heat transfer, the pressure load exerted on the structure by the fluid also depends on the surface area of the structure. This often requires the inclusion of computational fluid dynamics, in addition to structural and heat conduction analysis, to accurately account for the effect of the surrounding fluid with changing fluid-structure interface. However, it drastically increases the complexity and also computational cost to perform the optimization.

Other challenges include applying design boundary-dependent loads and boundary conditions in topology optimization. In many topology optimization problems, the boundary conditions are defined on the void-solid boundary of the domain. This boundary is often fuzzy, not well-defined and is expected to change during each iteration. Therefore, it is not straight-forward to apply these conditions as the shape of the design may change drastically from one iteration to the other. In terms of loading conditions, design-dependent loads add additional complexity to the problem. For example, in structural compliance minimization problems, centrifugal and thermal loads are often design dependent. The addition of material reduces the compliance by adding stiffness to the structure; at the same time, it also means more materials are present to withstand more centrifugal load and potentially also more thermal load, increasing the compliance further. Such complexity of conflicting load effects can add complexity to the problem and causes convergence issues.

### SUMMARY

Embodiments of the present invention address and overcome one or more of the above shortcomings and drawbacks, by providing methods, systems, and apparatuses related to topology optimization framework that is able to account for design-dependent load and boundary conditions.

According to some embodiments, a system includes a meshing module, one or more physics solvers, one or more sensitivity computation modules, and one or more optimizer modules. The meshing module generates a mesh of a design domain corresponding to an object to be manufactured. The physics solvers each generate physical field variables and objective values based on the mesh and boundary conditions specified on solid-void boundaries of the design domain. The sensitivity computation modules compute a sensitivity field based on the mesh and the physical field variables. The optimizer modules generate an updated design comprising new design variables by executing an optimization of the design domain based on the sensitivity field and the objective values. The physics solvers, the sensitivity computation modules, and the optimizer modules are iteratively executed until convergence to generate a final design based on the new design variables generated by the optimizer modules.

According to other embodiments, a method includes generating a mesh of a design domain and performing a design process over a plurality of iterations. The design process comprises the following elements. One or more physics solvers are used to generate one or more physical field variables and one or more objective values based on the mesh and one or more boundary conditions specified on solid-void boundaries of the design domain. One or more sensitivity computation modules are used to compute a sensitivity field based on the mesh and the physical field variables. One or more optimizer modules are used to generate an updated design comprising one or more new design variables by executing an optimization of the design domain based on the sensitivity field and the objective values. Following the design process, a final version of the updated design is presented.

In some embodiments, an article of manufacture for performing topology optimization comprises a non-transitory, tangible computer-readable medium holding computer-executable instructions for performing the aforementioned method.

Additional features and advantages of the invention will be made apparent from the following detailed description of illustrative embodiments that proceeds with reference to the accompanying drawings.

### BRIEF DESCRIPTION OF THE DRAWINGS

The foregoing and other aspects of the present invention are best understood from the following detailed description when read in connection with the accompanying drawings. For the purpose of illustrating the invention, there are shown in the drawings embodiments that are presently preferred, it being understood, however, that the invention is not limited to the specific instrumentalities disclosed. Included in the drawings are the following Figures:

FIG. 1 provides an example topology optimization framework that is able to account for multi-physics load and boundary conditions, according to some embodiments;

FIG. 2A shows an example of structural topology optimization (single physics);

FIG. 2B shows an example of a thermal topology optimization (single physics);

FIG. 2C shows a combination of thermal and structural topology optimization;

FIG. 3A shows conceptually the various elements that are used during evolution of loading/boundary conditions;

FIG. 3B shows how loading/boundary conditions can be evolved with a design, according to some embodiments;

FIG. 4A illustrates an example of flood-fill from initial design boundary (on discrete edges) to design space external boundaries;

FIG. 4B illustrates an example of flood-fill from design domain external boundary to initial design or new design;

FIG. 5A shows example equations used in topology optimization, according to some embodiments;

FIG. 5B shows an example sensitivity formulation, used in some embodiments;

FIG. 6A provides an example of how the framework discussed herein may be use to generate a topology optimized design, according to some embodiments;

FIG. 6B shows an adaptation of FIG. 6A to structural modeling, as may be used in some embodiments;

FIG. 6C shows an adaptation of FIG. 6A to thermal modeling, as may be used in some embodiments;

FIG. 7 provides an example of a parallel processing memory architecture 700 that may be utilized to perform computations related to topology optimization, according to some embodiments of the present invention.

### DETAILED DESCRIPTION

Systems, methods, and apparatuses are described herein which relate generally to a framework for topology optimization that is able to account for design-dependent load and boundary conditions, for multi-physics applications. This framework is designed as a “plug-n-play” system that can be readily configured with different physics-based models to solve a variety of design problems. Thus, for example, the framework discussed herein may be used to perform topology optimization using a single type of physics model (e.g., structural only, thermal only, flow only) or a combination of physics models (e.g., structural-thermal, structural-flow, thermal-flow). Moreover, the framework can be readily adapted to support additional physics models (acoustics, electromagnetics, etc.) as needed to support design development.

Topology optimization typically determines the distribution of two material states/types (e.g., distribution of solid and void within a domain) within the defined design space. The topology optimization solver assumes a design variable of material definition that ranges from 0 to 1 (later referred as density factor). For different physics applications, this factor may have different definitions. Additionally, it will be used in the optimization algorithm to modify the design based on the computed sensitivity. For instance, in structural topology optimization, when the density factor value is 1, it means that particular region is solid (having material density and property of solid). If it is 0, it means that that region is void (having material density close to zero). Typical material properties include Young's modulus and thermal conductivity. For other problems, different material properties may be defined as a function of the design variable. For example, in conjugate heat transfer, design variable of 1 refers to solid material properties and design variable of 0 denotes fluid material properties. For the intermediate density factor values, the relationship between density factor and material properties will be interpolated by a material interpolation scheme chosen by the user (e.g., Solid Isotropic Material with Penalization, Rational Approximation of Material Properties). One typical objective of topology optimization problems is to minimize compliance, but this framework can also apply to other types of objectives, and also multiple numbers of objectives and constraints.

This approach can be applied to 2D or 3D topology optimization, that can handle requirements of different types of physics (e.g., structural and thermal), either single physics or multi-physics. It also allows the application of both design-dependent loads and boundary conditions. The framework discussed herein is flexible so that when different physics are included, the tool will automatically interpret the density factors for the different physics accordingly.

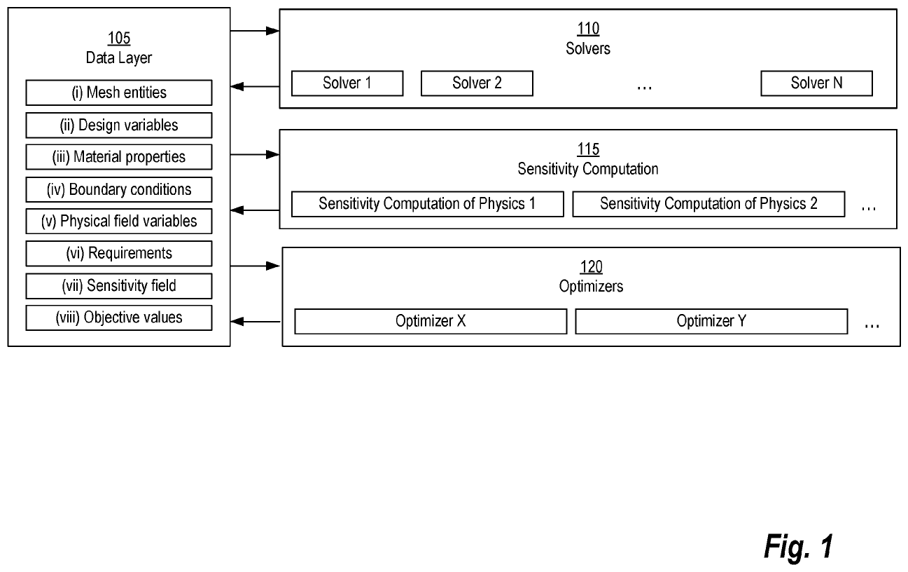

FIG. 1 provides an example topology optimization framework that is able to account for multi-physics load and boundary conditions, according to some embodiments. The framework includes a plurality of software modules organized as a Data Layer 105, Solvers 110, Sensitivity Computation of Physics Modules 115, and Optimizers 120. The term “module,” as used herein, refers to a software component that performs one or more functions. Each module may be a discrete unit, or the functionality of multiple modules can be combined into one or more units that form part of large program. In the example of FIG. 1, the Data Layer 105, Solvers 110, Sensitivity Computation of Physics Modules 115, and Optimizers 120 are organized to form the program for performing topology optimization.

The Data Layer 105 handles analysis data used in performing topology optimization. In the example of FIG. 1, 8 types of analysis data are shown: mesh entities (i.e., node sets, element sets, etc.); design variables; material properties; boundary conditions; physical field variables; requirements; sensitivity field data; and objective values for optimizations.

The Data Layer 105 is where topology optimization is triggered and iterated. The Data Layer 105 serves as the backbone to communicate with different analysis components (i.e., Solvers 110, Sensitivity Computation of Physics Modules 115, and Optimizers 120). For example, in some embodiments, the Data Layer 105 includes one or more application programming interfaces (APIs) that allow analysis components to access and update the analysis data. In network-based architectures, a Representational State Transfer (REST) design may be used to access and manipulate the analysis data at the Data Layer 105.

In some embodiments, the Data Layer 105 also includes utilities to automate operations on the mesh, boundary conditions, and analysis data. For example, when automatically detecting mesh regions, the design variable for the topology optimization domain can range from 0 to 1. For the clearance mesh regions (e.g., the region interfacing between moving and stationary components), the design variable is always 0, meaning no material is allowed to be added. Conversely, for the contact mesh region (e.g., region that is in contact with surrounding structures), the design variable is always 1, meaning there will always be material added at those regions.

The Solvers 110 include one or more physics solvers. Each solver obtains input data from the Data Layer 105, performs physics analysis (e.g., finite element analysis for structural, heat transfer, etc.), and provides the outputs of the analysis to the Data Layer 105.

The Sensitivity Computation of Physics Modules 115 uses one or more plug-ins to compute sensitivity of physics variables with respect to design variables. For different physics and objectives, different sensitivity computation modules may be used.

The Optimizers 120 use the objective values, the sensitivity field and the current design variables stored at the Data Layer 105, to compute new design variable fields. The specific optimizer(s) employed may be selected by the user for specific use cases.

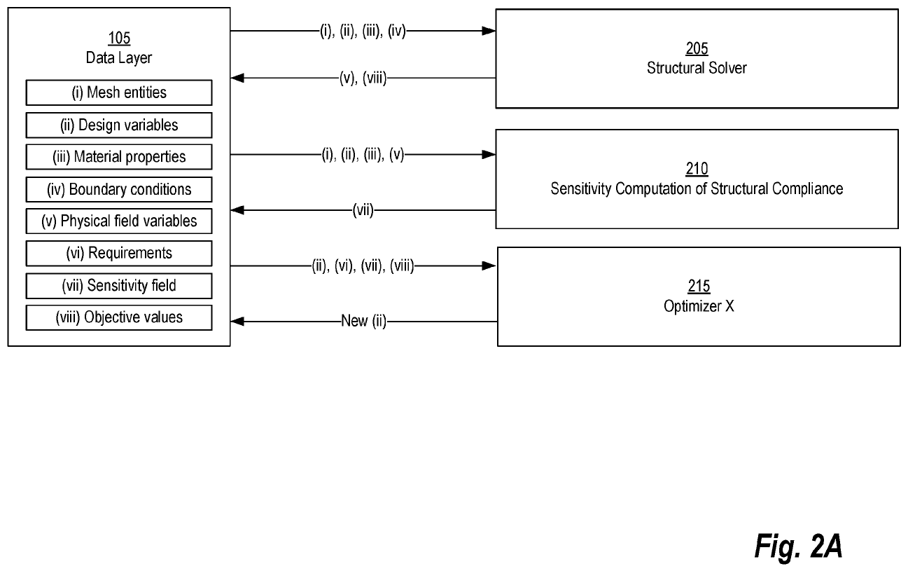

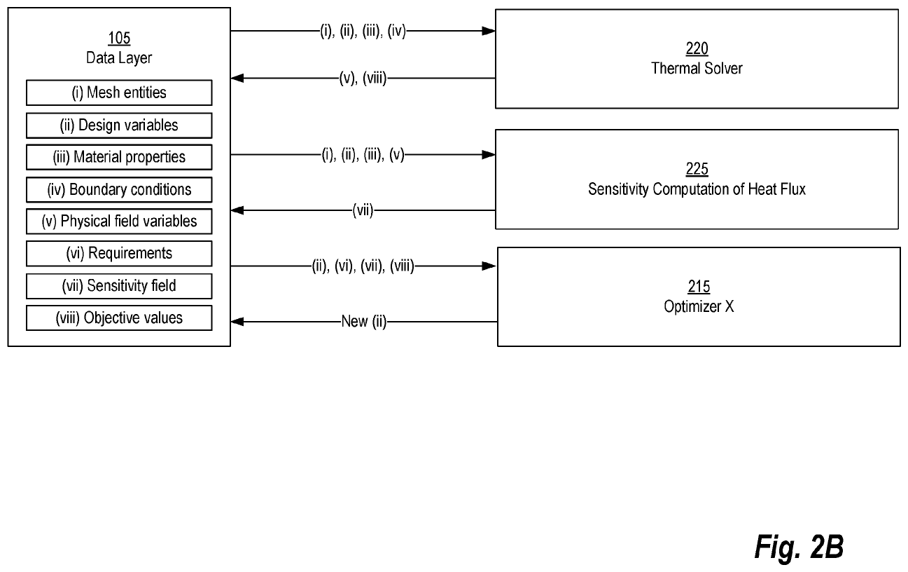

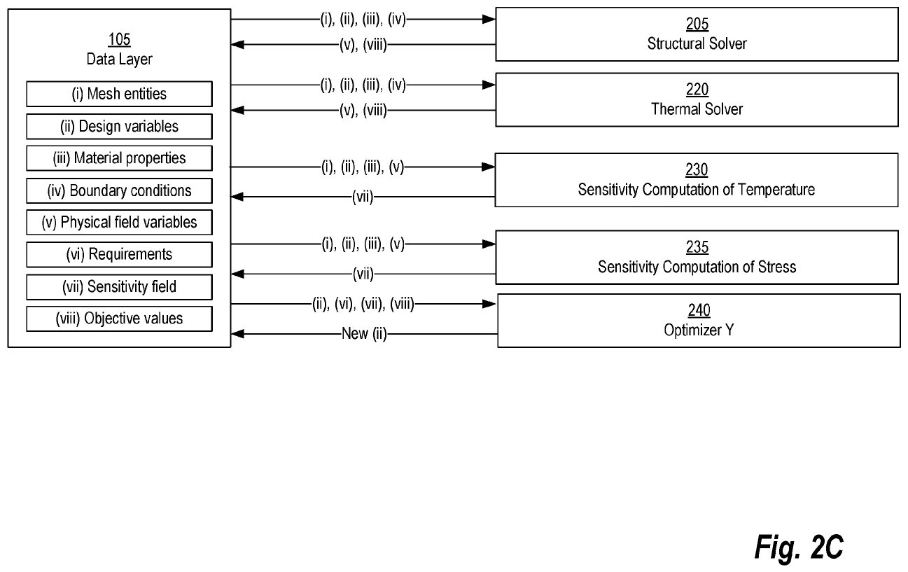

The framework shown in FIG. 1 is modular and flexible. It has componentized architecture to allow different solvers, different objective/cost functions and different optimizers to be included in the workflow. Different solvers, sensitivity computation plug-ins and optimizers can be used and coupled with the data layer to perform topology optimization based on the problem type. Some examples are shown in FIGS. 2A-2C. Specifically, FIG. 2A shows an example of structural topology optimization (single physics), while FIG. 2B shows an example of a thermal topology optimization (single physics). FIG. 2C shows a combination of thermal and structural topology optimization. Note that for each example shown in FIGS. 2A-2C roman numerals are used to identify the analysis data passed between the Data Layer 105 and the other solver, sensitivity computation, and optimizer modules.

The framework shown in FIG. 1 addresses two challenges related to design-dependent load and boundary conditions. The first challenge is to design boundary-dependent loads/boundary conditions that evolve with the design boundaries. Examples of such design boundary-dependent loads/boundary conditions include, without limitation convection boundary conditions and pressure load. The second challenge is addressing design-dependent loads that could result in conflicting sensitivity. Examples of such design-dependent loads include, without limitation, centrifugal load and thermos-elastic load. For loading and boundary conditions like pressure loads and convection boundary conditions, these conditions are often applied on the solid-void/fluid boundaries, for structural and thermal analysis respectively.

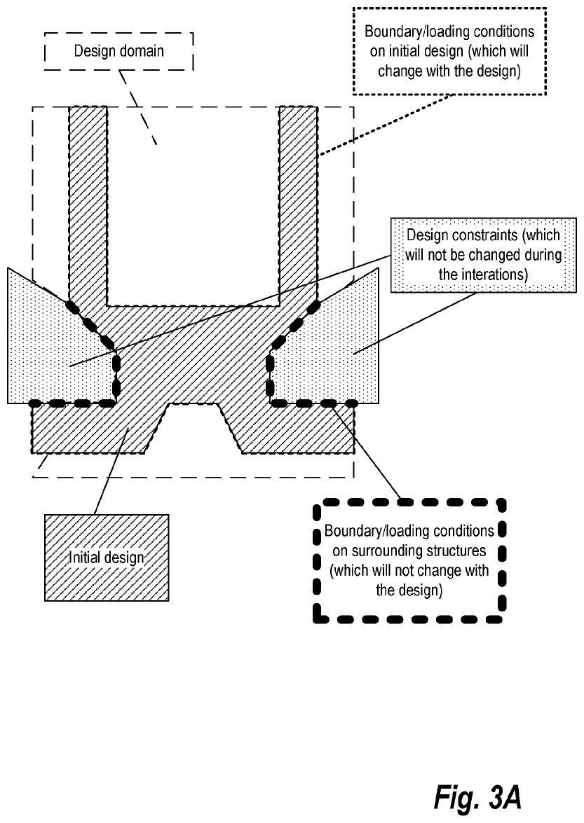

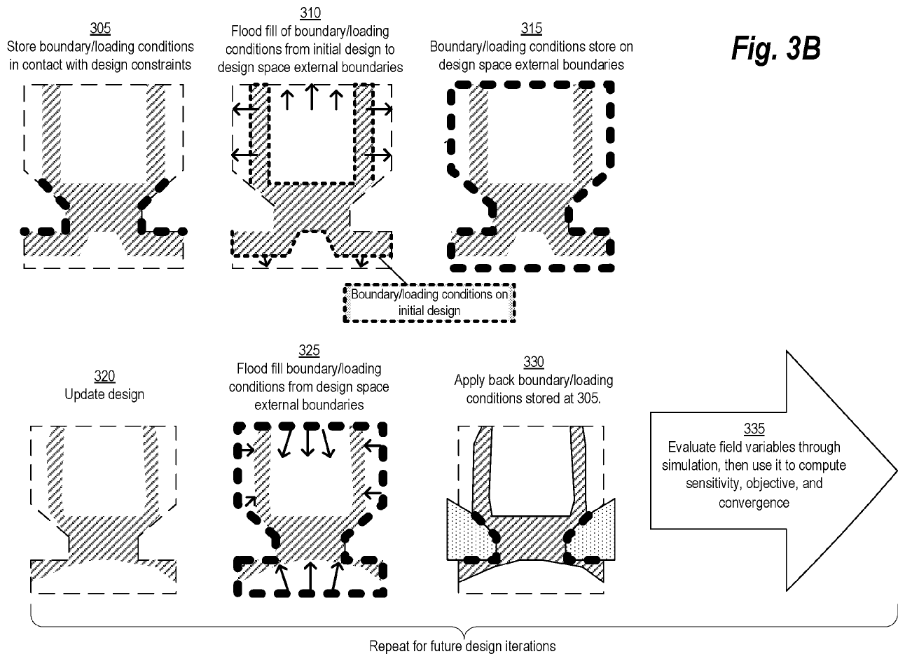

FIGS. 3A and 3B provide an example of how loading/boundary conditions can be evolved with the design, according to some embodiments. More specifically, FIG. 3A shows conceptually the various elements that are used during the evolution process, while FIG. 3B shows the steps involved in the evolution process itself.

As a pre-processing step, the initial boundary condition is defined. The initial setup comprises an initial design, with its associated boundary conditions (e.g., pressure, heat transfer coefficients) specified on its solid-void boundaries. Next, thresholding is applied to the density factor to identify boundaries. At each iteration, the entire design domain contains elements that have varying density factors. There are no clear design boundaries. Therefore, a density factor threshold (which can be specified by the user), is specified (e.g., 0.5). For elements with density factors larger than the threshold (e.g., ≥0.5), they will be regarded as solid. Elements with density factors lower that the threshold (e.g., <0.5) may be regarded as void.

During steps 305-335, as shown in FIG. 3B, flood filling of the boundary conditions is performed. Because the boundary/loading conditions are supposed to change with the design, it is important to be able to evolve these conditions as the design changes from one iteration to the other. Here, a flood-fill approach is utilized to spatially map these conditions so that the boundary/loading conditions will still resemble similarity with the initial design, while at the same time conform with the solid-void boundary of the current design iteration. As is generally understood, in the art, the term “flood filling” refers to an algorithm that identifies a group of nodes connected to a particular node. Once the group of nodes is identified, it can be “filled” by setting each node to a particular value. One common example of flood filling is used by the “bucket” tool used in graphics programs like Microsoft Paint™. With the bucket tool, the user clicks on a pixel of a particular color and requests that it be changed to a new color. Flood filling is then performed to change all pixels connected to the selected pixel to the new color. With the techniques described herein, the same general concept is adapted to populate boundary conditions across all the elements of the design.

Starting at step 305, the boundary/loading conditions (e.g., flow pressure, heat transfer coefficients) in contact with design constraints are stored. The stored boundary/loading conditions are those that do not require flood-filling (e.g., boundary conditions in contact with surrounding structures). The design constraints may include, for example, e.g., clearance and contact regions of the design space. At step 310, the boundary/loading conditions are flood filled from initial design to design space external boundaries. Next, at step 315 the boundary/loading conditions are stored on the design space external boundaries. This saves the spatial variation of the boundary condition that is similar to the initial design.

The design is updated at step 320 based on the new boundary/loading conditions. At step 325, the boundary conditions (saved at step 315) are flood-filled onto the solid-void boundaries of the updated design, based on the threshold of density factor (i.e., do not flood-fill into region which density factor is larger than the threshold). Next, at step 330, the boundary/loading conditions that were stored at step 305 are applied back to the design. Other boundary/loading conditions may also be applied (e.g., centrifugal load. Then, at step 335, a physics simulation is used to compute field variables (e.g., temperature, displacement, etc.). Based on the results, sensitivity, new objective value(s) and convergence are computed. Steps 320-335 are repeated if convergence criteria were not met.

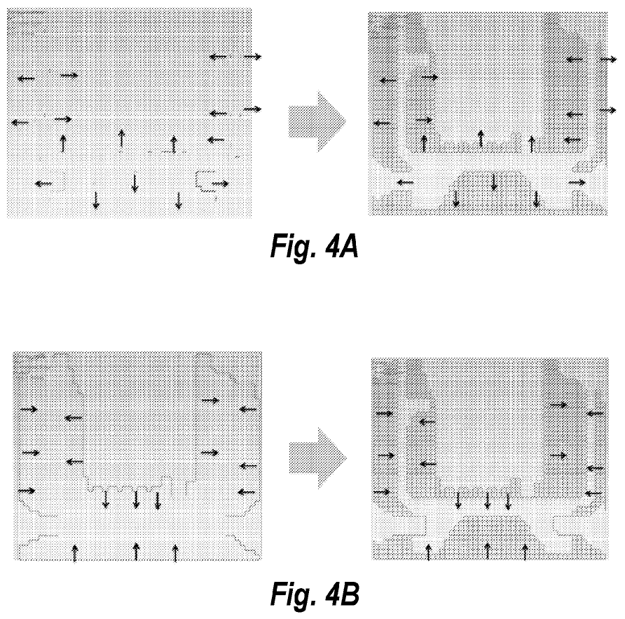

To illustrate how the spatial variation of the initial design was saved, FIG. 4A illustrates flood-fill from initial design boundary (on discrete edges) to design space external boundaries. FIG. 4B illustrates flood-fill from design domain external boundary to initial design or new design. The resemblance of the boundary conditions on the boundary of the initial design after two (outward and inward) flood-fills suggests that the spatial variation of the original boundary conditions was preserved.

While flood-fill can potentially be a powerful approach to approximate boundary conditions on design-dependent boundary/loading conditions, it might not be robust through the topology optimization. Especially during the initial iterations of topology optimization the solid-void boundaries are not well defined yet. Pre-mature flood-fill can cause the boundary conditions to be mapped on these fuzzy boundaries, altering the solution and resulting in oscillation of the solution.

To improve the robustness and reduce the oscillation due to the flood-filling of the boundary/loading conditions, we applied a technique to slowly increase the density factor threshold during the optimization. It involves starting with a lower density factor threshold such that most elements are considered as solid at the beginning; and the boundary/loading conditions would not involve much. Then, gradually increase the density factor threshold to larger value once the design stabilizes (reached local convergence). This allows the holes (topology) to stabilize first based on boundary-independent load/boundary conditions before flood-filing these conditions into these holes.

This approach is outlined in the following steps. The user first initializes the following parameters: initial value of density factor threshold (e.g., 0.2), the maximum value of density factor threshold (e.g., 0.8), and the delta of density factor threshold (e.g., 0.1). This means that density factor threshold will increase from 0.2, 0.3, 0.4 . . . till it reaches 0.8, throughout the topology optimization. The, topology is performed over a plurality of iterations. For each iteration, if the change in objective (e.g., compliance) is within some user-defined convergence criteria (e.g., 1% of the initial value), and a predetermined number of iterations (e.g., 15) have passed since the previous threshold update, then the density factor threshold is increased by pre-determined delta (i.e. 0.1), until threshold is equal to a desired max threshold value (i.e. 0.8). This allows gradual increase in density factor threshold and a more stable solution with boundary-dependent loads/BCs.

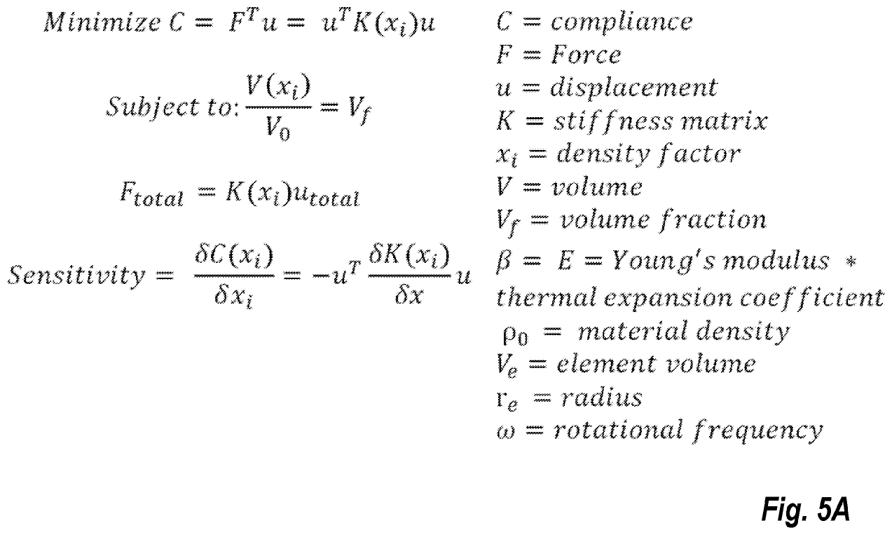

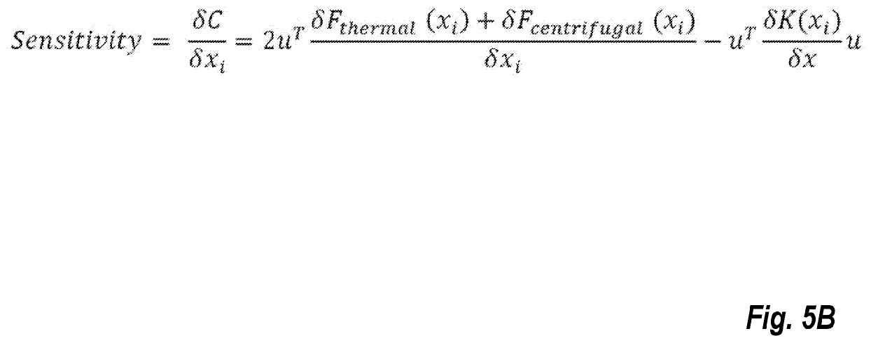

As noted above, the other challenge related to design-dependent load and boundary conditions is the complication of having conflicting sensitivity involved in the objective function. For instance, in structural compliance minimization, with design-independent load, structural compliance can be reduced by adding material because the sensitivity of the compliance with respect to the design variable (density factor) is negative. In this context, the topology can be formulated as in FIG. 5A.

However, for certain design-dependent load (e.g., centrifugal loads and thermal loads), adding more material can increase structural compliance because adding more material will increase the material that is subjected to thermal load and centrifugal loads. As a result, sensitivity is formulated as shown in FIG. 5B. Therefore, the sensitivity of the compliance with respect to density factor might not be negative, and can fluctuate between positive and negative depending on where the material is applied and the amount of loading it is subjected to. Also, if loading magnitude of these loads is dominant, a majority of design materials may be removed to minimize compliance. In addition, with these conflicting sensitivity parameters (with positive and negative components that cancel each other from time to time), convergence can become an issue.

Therefore, to improve the convergence of objective with conflicting sensitivities, a special material interpolation scheme may be utilized. First of all, instead of the typical solid isotropic material penalization scheme, the rational approximation of material properties (RAMP) method is being used. This has been demonstrated to be useful in improving convergence in problems with thermoelastic loads. In addition to using RAMP for material interpolation, some embodiments utilize an approach to improve convergence by gradually increasing the RAMP penalization factor to reduce the amount of intermediate density factor values in final design. This reduces oscillatory behavior of the solution to improve the convergence of the final design.

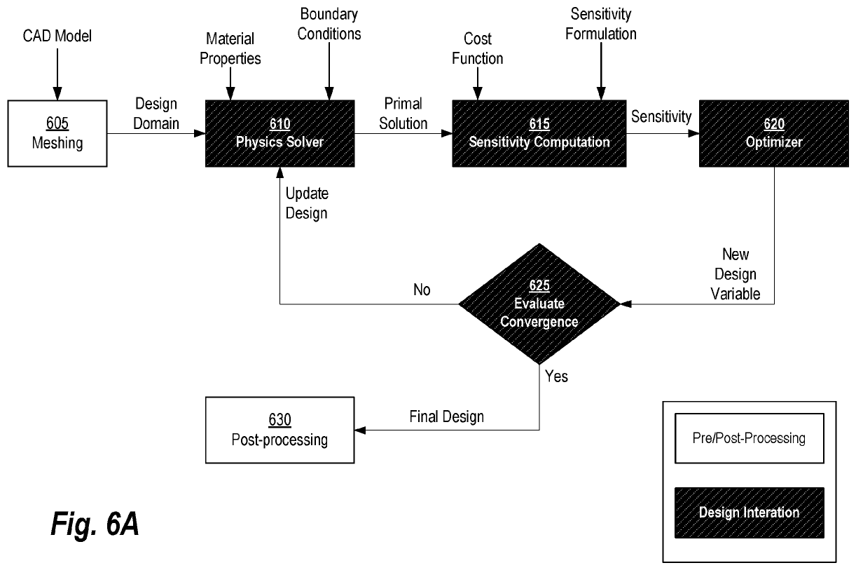

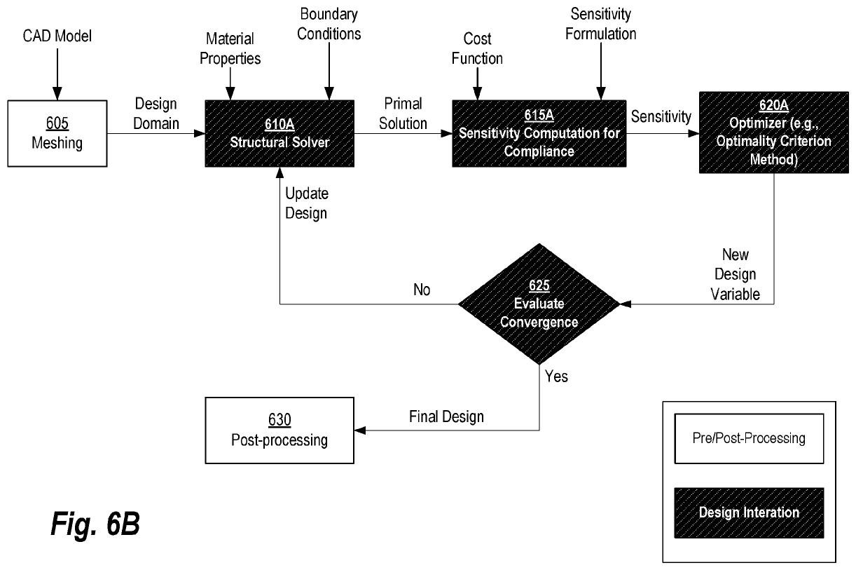

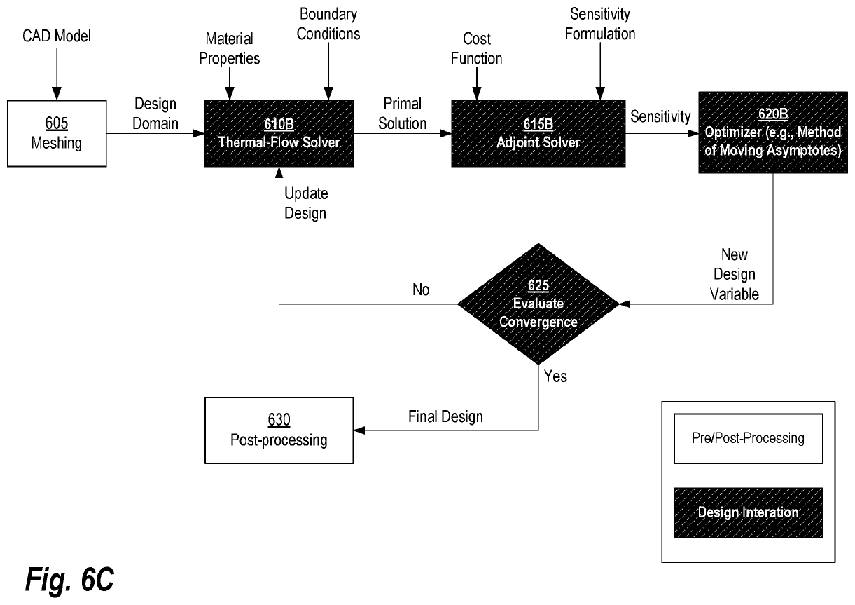

FIG. 6A provides an example of how the framework discussed herein may be use to generate a topology optimized design, according to some embodiments. Starting at 605, a meshing module generates a mesh of a design domain corresponding to an object to be manufactured. This design domain is processed by a Physics Solver 610, with material properties and boundary conditions, to generate a primal solution comprising one or more physical field variables and one or more objective values based on the mesh and one or more boundary conditions specified on solid-void boundaries of the design domain. A Sensitivity Computation Module 615 generates a sensitivity field based on the primal solution, a cost function and a sensitivity formulation (as described above with reference to FIGS. 5A and 5B). An Optimizer 620 generates an updated design comprising one or more new design variables by executing an optimization of the design domain based on the sensitivity field and one or more objective values. An Evaluate Convergence Module 625 determines if the design has converged, for example, by comparing the updated design to the design from the previous iteration. It should be noted that, although the Evaluate Convergence Module 625 is shown as discrete module in FIG. 6A, in other embodiments, the functionality can be incorporated into one of the other modules (e.g., the Optimizer 620 or the Data Layer 105 described in FIG. 1). If the design has not converged, the updated design is used as input into the Physics Solver and the process described above is performed for another iteration. Conversely, if the design has converged, a Post-Processing Module 630 performs any post-processing tasks on the final design. This post-processing may include, for example, translation of the final design into instructions that may be executed by a 3-D printer or other fabrication device to create a physical representation of the design. Techniques for translation of a design to such instructions are device specific and generally known in the art; thus, such techniques are not described in detail herein.

FIGS. 6B and 6C illustrate the flexibility of the framework by showing how the process shown in FIG. 6A can be adapted to different design activities. In FIG. 6B, the Physics Solver 610, Sensitivity Computation Module 615, and Optimizer 620 shown in FIG. 6A have been specified to be, respectively, a Structural Solver 610A, a Sensitivity Computation for Compliance Module 615A, and an Optimizer 620A performing an Optimality Criterion Method. In FIG. 6C, the Physics Solver 610, Sensitivity Computation Module 615, and Optimizer 620 have been specified to be, respectively, a Thermal Flow Solver 610B, an Adjoint Solver 615B, and an Optimizer 620B performing an Method of Moving Asymptotes.

The topology optimization framework disclosed herein provides various benefits over conventional solutions. For example, the flood-filling of boundary-dependent loads and boundary conditions results in significant saving of computational cost and complexity. Additionally, the disclosed framework provides the ability to include multiple physics solvers to be included in topology optimization, enabling designing for more complex problems. Moreover, the framework allows users to select different optimizers suitable for different problems irrespective of the physic solver used, resulting in more design flexibility and potential time savings during execution. Time savings are also realized by the improved convergence of the disclosed framework, which ensures that less time is required to achieve a final design.

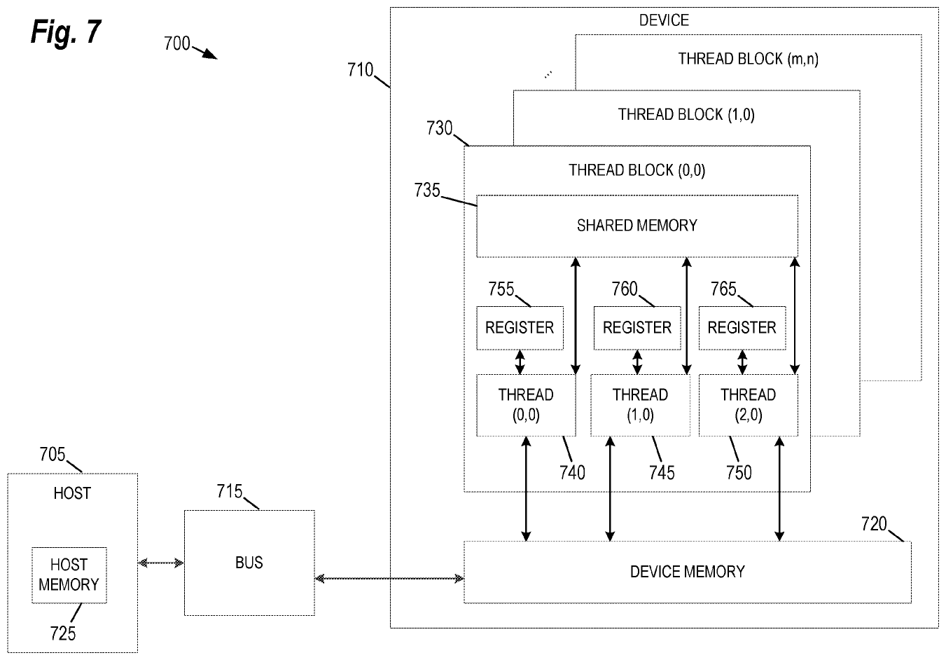

FIG. 7 provides an example of a parallel processing memory architecture 700 that may be utilized to perform computations related to topology optimization, according to some embodiments of the present invention. This architecture 700 may be used in embodiments of the present invention where NVIDIA™ CUDA (or a similar parallel computing platform) is used. The architecture includes a host computing unit (“host”) 705 and a GPU device (“device”) 710 connected via a bus 715 (e.g., a PCIe bus). The host 705 includes the central processing unit, or “CPU” (not shown in FIG. 7) and host memory 725 which is accessible to the CPU. The device 710 includes the graphics processing unit (GPU) and its associated memory 720, referred to herein as device memory. The device memory 720 may include various types of memory, each optimized for different memory usages. For example, in some embodiments, the device memory includes global memory, constant memory, and texture memory.

Parallel portions of a deep learning application may be executed on the architecture 700 as “device kernels” or simply “kernels.” A kernel comprises parameterized code configured to perform a particular function. The parallel computing platform is configured to execute these kernels in an optimal manner across the architecture 700 based on parameters, settings, and other selections provided by the user. Additionally, in some embodiments, the parallel computing platform may include additional functionality to allow for automatic processing of kernels in an optimal manner with minimal input provided by the user.

The processing required for each kernel is performed by a grid of thread blocks (described in greater detail below). Using concurrent kernel execution, streams, and synchronization with lightweight events, the architecture 700 of FIG. 7 (or similar architectures) may be used to parallelize various operations associated with executing the physics solver, sensitivity computation, and/or optimizer operations described herein. For example, in some embodiments, the mesh describing the design domain is divided into a plurality of sections and multiple versions of the physics solver are applied to the sections in parallel.

The device 710 includes one or more thread blocks 730 which represent the computation unit of the device 710. The term thread block refers to a group of threads that can cooperate via shared memory and synchronize their execution to coordinate memory accesses. For example, in FIG. 7, threads 740, 745 and 750 operate in thread block 730 and access shared memory 735. Depending on the parallel computing platform used, thread blocks may be organized in a grid structure. A computation or series of computations may then be mapped onto this grid. For example, in embodiments utilizing CUDA, computations may be mapped on one-, two-, or three-dimensional grids. Each grid contains multiple thread blocks, and each thread block contains multiple threads. For example, in FIG. 7, the thread blocks 730 are organized in a two dimensional grid structure with m+1 rows and n+1 columns. Generally, threads in different thread blocks of the same grid cannot communicate or synchronize with each other. However, thread blocks in the same grid can run on the same multiprocessor within the GPU at the same time. The number of threads in each thread block may be limited by hardware or software constraints. In some embodiments, processing of different regions of the mesh may be partitioned over thread blocks automatically by the parallel computing platform software.

Continuing with reference to FIG. 7, registers 755, 760, and 765 represent the fast memory available to thread block 730. Each register is only accessible by a single thread. Thus, for example, register 755 may only be accessed by thread 740. Conversely, shared memory is allocated per thread block, so all threads in the block have access to the same shared memory. Thus, shared memory 735 is designed to be accessed, in parallel, by each thread 740, 745, and 750 in thread block 730. Threads can access data in shared memory 735 loaded from device memory 720 by other threads within the same thread block (e.g., thread block 730). The device memory 720 is accessed by all blocks of the grid and may be implemented by using, for example, Dynamic Random-Access Memory (DRAM).

Each thread can have one or more levels of memory access. For example, in the architecture 700 of FIG. 7, each thread may have three levels of memory access. First, each thread 740, 745, 750, can read and write to its corresponding registers 755, 760, and 765. Registers provide the fastest memory access to threads because there are no synchronization issues and the register is generally located close to a multiprocessor executing the thread. Second, each thread 740, 745, 750 in thread block 730, may read and write data to the shared memory 735 corresponding to that block 730. Generally, the time required for a thread to access shared memory exceeds that of register access due to the need to synchronize access among all the threads in the thread block. However, like the registers in the thread block, the shared memory is typically located close to the multiprocessor executing the threads. The third level of memory access allows all threads on the device 710 to read and/or write to the device memory. Device memory requires the longest time to access because access must be synchronized across the thread blocks operating on the device. Thus, in some embodiments, the processing of each module is coded such that it primarily utilizes registers and shared memory and only utilizes device memory as necessary to move data in and out of a thread block.

The embodiments of the present disclosure may be implemented with any combination of hardware and software. For example, aside from parallel processing architecture presented in FIG. 7, standard computing platforms (e.g., servers, desktop computer, etc.) may be specially configured to perform the techniques discussed herein. In addition, the embodiments of the present disclosure may be included in an article of manufacture (e.g., one or more computer program products) having, for example, computer-readable, non-transitory media. The media may have embodied therein computer readable program codes for providing and facilitating the mechanisms of the embodiments of the present disclosure. The article of manufacture can be included as part of a computer system or sold separately.

Unless stated otherwise as apparent from the following discussion, it will be appreciated that terms such as “applying,” “generating,” “identifying,” “determining,” “processing,” “computing,” “selecting,” or the like may refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices. Embodiments of the methods described herein may be implemented using computer software. If written in a programming language conforming to a recognized standard, sequences of instructions designed to implement the methods can be compiled for execution on a variety of hardware platforms and for interface to a variety of operating systems. In addition, embodiments of the present invention are not described with reference to any particular programming language. It will be appreciated that a variety of programming languages may be used to implement embodiments of the present invention.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters.

A “graphical user interface” (GUI), as used herein, comprises one or more display images, generated by a display processor and enabling user interaction with a processor or other device and associated data acquisition and processing functions. The GUI also includes an executable procedure or executable application. The executable procedure or executable application conditions the display processor to generate signals representing the GUI display images. These signals are supplied to a display device which displays the image for viewing by the user. The processor, under control of an executable procedure or executable application, manipulates the GUI display images in response to signals received from the input devices. In this way, the user may interact with the display image using the input devices, enabling user interaction with the processor or other device.

The functions and process steps herein may be performed automatically or wholly or partially in response to user command. An activity (including a step) performed automatically is performed in response to one or more executable instructions or device operation without user direct initiation of the activity.

The system and processes of the figures are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. As described herein, the various systems, subsystems, agents, managers and processes can be implemented using hardware components, software components, and/or combinations thereof. No claim element herein is to be construed under the provisions of 35 U.S.C. 112(f) unless the element is expressly recited using the phrase “means for”.

1. A system comprising:
a meshing module generating a mesh of a design domain corresponding to an object to be manufactured;
one or more physics solvers each generating one or more physical field variables and one or more objective values based on the mesh and one or more boundary conditions specified on solid-void boundaries of the design domain;
one or more sensitivity computation modules computing a sensitivity field based on the mesh and the physical field variables;
one or more optimizer modules generating an updated design comprising one or more new design variables by executing an optimization of the design domain based on the sensitivity field and the objective values;
wherein the physics solvers, the sensitivity computation modules, and the optimizer modules are iteratively executed until convergence to generate a final design based on the new design variables generated by the optimizer modules.

2. The system of claim 1,
wherein the boundary conditions are modified during each iteration.

3. The system of claim 1,
wherein (i) the mesh comprises plurality of elements and each element is associated with a density factor and (ii) if the density factor associated with an element is above a predetermined threshold, the element is designated as solid in the updated design, and (iii) if the density factor associated with an element is below the predetermined threshold, the element is designated as void in the updated design.

4. The system of claim 3,
wherein the predetermined threshold is adjusted between iterations based on one or more of (i) a degree of change of the objective values compared to a previous iteration and (ii) a number of iterations that have passed since a previous pre-determined threshold adjustment.

5. The system of claim 1,
wherein (i) the mesh comprise plurality of elements and each element is associated with a density factor and (ii) the one or more new design variables comprise an adjustment to the density factors associated with one or more the elements.

6. The system of claim 5,
wherein the adjustment to the density factors is made using a user-selected material interpolation scheme.

7. The system of claim 6,
wherein the user-selected material interpolation scheme is Solid Isotropic Material with Penalization scheme.

8. The system of claim 6,
wherein the user-selected material interpolation scheme is Rational Approximation of Material Properties (RAMP) scheme.

9. The system of claim 1, further comprising:
a boundary condition evolution module configured to:
determine initial boundary conditions using a first process comprising:
receiving a plurality of design constraints,
storing boundary conditions in contact with the design constraints,
adapting the boundary conditions to external boundaries of the design domain using a flood filling technique,
storing the boundary conditions on the external boundaries of the design domain; and
following generation of each updated design, performing a second process comprising:
adapting the boundary conditions on the external boundaries to the updated design using a flood filling technique, and
applying boundary conditions in contact with the design constraints to the updated design.

10. The system of claim 1,
wherein the mesh is a finite elements analysis (FEA) mesh of an initial design.

11. The system of claim 1, wherein:
the physics solvers comprise a structural solver,
the sensitivity computation modules comprise at least one sensitivity computation module computing sensitivity for compliance, and
at least one of the optimizer modules employs an optimality criterion method to generate at least a portion of the updated design.

12. The system of claim 1, wherein:
the physics solvers comprise a thermal flow solver,
the sensitivity computation modules comprise an adjoint solver, and
at least one of the optimizer modules employs a method of moving asymptotes to generate at least a portion of the updated design.

13. The system of claim 1, further comprising:
one or more 3-D printers configured to print representations of the object based on the final design.

14. A method comprising:
generating a mesh of a design domain;
performing a design process over a plurality of iterations comprising:
generating, using one or more physics solvers, one or more physical field variables and one or more objective values based on the mesh and one or more boundary conditions specified on solid-void boundaries of the design domain,
computing, using one or more sensitivity computation modules, a sensitivity field based on the mesh and the physical field variables, and
generating, using one or more optimizer modules, an updated design comprising one or more new design variables by executing an optimization of the design domain based on the sensitivity field and the objective values; and
following the design process, presenting a final version of the updated design.

15. The method of claim 14, further comprising:
modifying the boundary conditions following each iteration based on the updated design.

16. The method of claim 14,
wherein (i) the mesh comprises plurality of elements and each element is associated with a density factor and (ii) if the density factor associated with an element is above a predetermined threshold, the element is designated as solid in the updated design, and (iii) if the density factor associated with an element is below the predetermined threshold, the element is designated as void in the updated design.

17. The method of claim 16,
wherein the predetermined threshold is adjusted between iterations based on one or more of (i) a degree of change of the objective values compared to a previous iteration and (ii) a number of iterations that have passed since a previous pre-determined threshold adjustment.

18. The method of claim 14,
wherein (i) the mesh comprises plurality of elements and each element is associated with a density factor and (ii) the one or more new design variables comprise an adjustment to the density factors associated with one or more the elements.

19. The method of claim 14, further comprising:
determining initial boundary conditions using a first process comprising:
receiving a plurality of design constraints,
storing boundary conditions in contact with the design constraints,
adapting the boundary conditions to external boundaries of the design domain using a flood filling technique,
storing the boundary conditions on the external boundaries of the design domain; and
following generation of each updated design, performing a second process comprising:
adapting the boundary conditions on the external boundaries to the updated design using a flood filling technique, and
applying boundary conditions in contact with the design constraints to the updated design.

20. An article of manufacture for performing topology optimization, the article of manufacture comprising a non-transitory, tangible computer-readable medium holding computer-executable instructions for performing a method comprising:
generating a mesh of a design domain corresponding to an object to be manufactured;
performing a design process over a plurality of iterations comprising:
generating, using one or more physics solvers, one or more physical field variables and one or more objective values based on the mesh and one or more boundary conditions specified on solid-void boundaries of the design domain,
computing, using one or more sensitivity computation modules, a sensitivity field based on the mesh and the physical field variables, and
generating, using one or more optimizer modules, an updated design comprising one or more new design variables by executing an optimization of the design domain based on the sensitivity field and the objective values; and
following the design process, presenting a final version of the updated design
